(19) United States
(12) Patent Application Publication
(10) Pub. No.: US 2025/0374944 A1
(43) Pub. Date: Dec. 11, 2025

(54) LAVENDER SUGAR COMPOSITION AND METHOD FOR MAKING AND USING SAME

(71) Applicant: Starbucks Corporation, Seattle, WA (US)

(72) Inventors: Kristin T. Murray, Seattle, WA (US); Patrick M. Penny, Seattle, WA (US); Emily S. Fazio, Seattle, WA (US); Lisa L. Beckman, Kent, WA (US)

(21) Appl. No.: 19/233,853

(22) Filed: Jun. 10, 2025

Related U.S. Application Data
(60) Provisional application No. 63/658,562, filed on Jun. 11, 2024.

(51) Int. Cl. A23L 27/10; A23L 2/54; A23L 2/56; A23L 2/58; A23L 2/60; A23L 5/43

(52) U.S. Cl. CPC A23L 27/10; A23L 2/54; A23L 2/56; A23L 2/58; A23L 2/60; A23L 5/43

(57) ABSTRACT

The disclosure relates to particulate compositions comprising a natural sugar, a salt, a floral flavorant (e.g., a lavender flavorant, a rose flavorant, a jasmine flavorant, a hibiscus flavorant, a cherry blossom flavorant, an orange blossom flavorant, an osmanthus flavorant, an orchid flavorant, a Gardenia flavorant, a chamomile flavorant, a Chrysanthemum flavorant, a elderflower flavorant, a geranium flavorant, a violet flavorant, a poppy flavorant), a natural colorant, and an oil. As detailed herein, the disclosed particulate compositions can be combined with sweet cream to form a foam, which foam can be added into or onto a beverage. Alternatively, the disclosed particulate compositions can be combined directly into the beverage itself. This abstract is intended as a scanning tool for purposes of searching in the particular art and is not intended to be limiting of the present disclosure.

### CROSS-REFERENCE TO RELATED APPLICATIONS

This application claims the benefit of U.S. Application No. 63/658,562, filed on Jun. 11, 2024, the contents of which are incorporated herein by reference in their entirety.

### BACKGROUND

Consumer interest in wellness has continued to increase post-pandemic, with mental well-being and self-care continuing to be top priorities. Perhaps unsurprisingly, this trend has carried over into a growing demand for naturally sourced ingredients and natural flavorings in food and beverages. Floral ingredients, in particular, have been growing in popularity because of their holistic properties and other functional benefits. For example, hibiscus and elderflower, which are high in antioxidants and vitamin C, can boost the immune system. Lavender is known for its ability to calm the nervous system and has also been shown to reduce pain and inflammation. Rose supports the body's natural collagen production. For at least these reasons, floral ingredients are increasingly being used in food and beverage products.

For beverages, floral ingredients are typically added as a simple syrup. Sugar is combined with water in a ratio of about 2:1 and heated to dissolve the syrup. The flower (e.g., edible flower) is added directly to the simmering syrup to extract the flavor. Alternatively, the flowers can be steeped in boiling water to provide a floral tea. The beverage can then be sweetened to taste. Unfortunately, both of these processes involve heating the flower, which can significantly diminish the floral flavor and color.

There are also further complexities that arise when incorporating floral ingredients into products for consumption. Notably, the goal is typically to provide the consumer with an experience, not just a food or beverage product. It is, therefore, desirable to incorporate a floral aroma, a floral color, and a floral flavor into the product. The floral flavor can often be overpowering, herbal, or bitter, and so a delicate balance must be maintained to avoid under- or over-inclusion. Further, if the aroma is sufficient, the flavor may be too much and vice versa. Thus, the product often sacrifices one property for the benefit of the other.

Despite the widespread popularity of floral products, floral ingredients that can be prepared for use in food and beverage products without heating and that endow the product with an experience that balances the aroma, the color, and the flavor has remained elusive. These needs and others are met by the present invention.

### SUMMARY

In accordance with the purpose(s) of the invention, as embodied and broadly described herein, the invention, in one aspect, relates to particulate compositions comprising a natural sugar, a salt, a floral flavorant (e.g., a lavender flavorant, a rose flavorant, a jasmine flavorant, a hibiscus flavorant, a cherry blossom flavorant, an orange blossom flavorant, an osmanthus flavorant, an orchid flavorant, a Gardenia flavorant, a chamomile flavorant, a Chrysanthemum flavorant, a elderflower flavorant, a geranium flavorant, a violet flavorant, a poppy flavorant), a natural colorant, and an oil. As detailed herein, the disclosed particulate compositions can be combined with sweet cream to form a foam, which foam can be added into or onto a beverage. Alternatively, the disclosed particulate compositions can be combined directly into the beverage itself.

Thus, disclosed are particulate compositions comprising: (a) a natural sugar; (b) a salt; (c) a floral flavorant; (d) a natural colorant; and (e) an oil, wherein the oil and the floral flavorant are present in the particulate composition in a ratio of from about 0.04 to about 0.12.

Also disclosed are foams comprising a sweet cream and a disclosed particulate composition.

Also disclosed are beverages comprising a disclosed foam.

Also disclosed are beverages comprising a disclosed particulate composition.

Also disclosed are kits comprising a disclosed particulate composition and one or more selected from: (a) a sweet cream; (b) a beverage; (c) instructions for making a foam; and (d) instructions for making a beverage.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 shows a representative image of an exemplary particulate composition that is fine and free flowing with a light purple color.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compositions, liquid concentrates, and/or beverages are disclosed and described, it is to be understood that they are not limited to specific methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Disclosed are the components to be used to prepare the compositions, liquid concentrates, and/or beverages of the invention as well as the compositions, liquid concentrates, and/or beverages themselves to be used within the methods disclosed herein. These and other materials are disclosed herein, and it is understood that when combinations, subsets, interactions, groups, etc. of these materials are disclosed that while specific reference of each various individual and collective combinations and permutation of these capsules cannot be explicitly disclosed, each is specifically contemplated and described herein. For example, if a particular composition is disclosed and discussed and a number of modifications that can be made to a number of materials including the compositions are discussed, specifically contemplated is each and every combination and permutation of the composition and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including steps in methods of making and using the capsules and compositions of the invention. Thus, if there are a variety of additional steps that can be performed it is understood that each of these additional steps can be performed with any specific embodiment or combination of embodiments of the methods of the invention.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. DEFINITIONS

As used in the specification and the appended claims, the singular forms “a,” “an” and “the” include plural referents unless the context clearly dictates otherwise. Thus, for example, reference to “a particulate composition,” “a foam,” or “a beverage” includes mixtures of two or more such particulate compositions, foams, beverages, and the like.

References to a particulate composition, a foam, or a beverage containing “an” ingredient is intended to include other ingredients, respectively, in addition to the one named.

By “comprising” or “containing” or “having” it is intended that at least the named component, element, material, or method step, etc., is present in the particulate composition, foam, or beverage, but does not exclude the presence of other components, elements, materials, method steps, etc., even if the other such components, elements, materials, method steps, etc., have the same function as what is named, unless expressly excluded in the claims.

The term “consisting essentially of,” as used herein, means that the particulate composition, the foam, or the beverage contains the named components, elements, materials, or method steps and does not contain any other structural components. As would be understood by one of skill in the art, however, there can yet be additional decorative and/or ornamental features such as, for example, coloring.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where said event or circumstance occurs and instances where it does not.

The term “uniform blend,” when used in relation to the particulate composition, means that the components of the composition are evenly distributed throughout the composition. As such, when the particulate composition is a uniform blend of the various components, the composition has a uniform texture.

The term “substantially,” when used in relation to the uniform blend, means that the components of the composition are mostly evenly distributed throughout the composition. Thus, for example, the components can be at least 75% evenly distributed, at least 80% evenly distributed, at least 85% evenly distributed, at least 90% evenly distributed, at least 95% evenly distributed, at least 99% evenly distributed, or more than 99% evenly distributed.

As used herein, the term “beverage” refers to a liquid good or product that is intended for consumption by, for example, a human. Examples of beverages include, but are not limited to, coffees such as instant coffees, cold brews, hot brews, traditional brews, and blended coffees, teas, fruit juices, smoothies, waters such as still waters and sparkling waters, liquors, liqueurs, and mixtures thereof. Further exemplary beverages suitable for the compositions disclosed herein include juices, fruit-flavored waters, still waters, teas, and smoothies.

### B. PARTICULATE COMPOSITIONS

In one aspect, disclosed are particulate compositions comprising: (a) a natural sugar; (b) a salt; (c) a floral flavorant; (d) a natural colorant; and (c) an oil, wherein the oil and the floral flavorant are present in the particulate composition in a ratio of from about 0.04 to about 0.12.

As detailed herein, the disclosed particulate composition can be prepared via blending and sifting process steps, without necessitating the use of heat. In this way, the floral properties (e.g., taste, aroma, color) of the composition are not negatively impacted. Moreover, the ratio of the components relative to the floral flavorant are particularly selected such that a balance is obtained amongst the floral properties. For example, a sweet, floral undertone (in flavor, in aroma) is maintained, while herbaceous undertones (in flavor, in aroma) are minimized. In addition, the color of the particulate composition can be matched to that of the floral component to further add to the experience that the composition endows to a foam, but can also be minimized such that color is not imparted-(or, is only minimally imparted) to a beverage.

In various aspects, the particulate composition consists essentially of: (a) the natural sugar; (b) the salt; (c) the floral flavorant; (d) the natural colorant; and (c) the oil.

As detailed herein, the term “natural sugar” means a sugar that comes from a natural source such as a plant. As used herein, the term “natural sugar” does not include sugar alcohols (e.g., arabitol, polyglucitol, erythritol, glycerol, isomalt, lactitol, maltitol, mannitol, xylitol, sorbitol), which refer to organic compounds that are derived from a sugar and that contain a hydroxyl group attached to each carbon atom. Neither does the term “natural sugar” encompass sugar substitutes, which can provide a sweetness similar to that of sugar, but contain significantly less food energy than a sugar-based sweetener. Common sugar substitutes can be obtained by manufacturing plant extracts or prepared synthetically. Examples of sugar substitutes include aspartame, monk fruit extract, saccharin, sucralose, stevia, acesulfame potassium (ace-K), and cyclamate. As used herein, the term “natural sugar” also excludes natural sweeteners and natural sweetener extracts such as stevia extract and monk fruit extract.

Thus, in various aspects, the natural sugar comprises fructose, glucose, lactose, galactose, maltose, and sucrose, or a mixture thereof. In a further aspect, the natural sugar comprises fructose, glucose, and sucrose, or a mixture thereof. In a still further aspect, the natural sugar is a cane sugar. In yet a further aspect, the cane sugar is pure cane granulated sugar.

In various aspects, the natural sugar is a particulate.

In various aspects, the natural sugar is present in the particulate composition in an amount of from about 92 wt % to about 97 wt %. Thus, in various aspects, the natural sugar is present in the particulate composition in an amount of from about 92 wt % to about 96 wt %, from about 92 wt % to about 95 wt %, from about 92 wt % to about 94 wt %, from about 92 wt % to about 93 wt %, from about 93 wt % to about 97 wt %, from about 94 wt % to about 97 wt %, from about 95 wt % to about 97 wt %, from about 96 wt % to about 97 wt %, from about 93 wt % to about 96 wt %, or from about 94 wt % to about 95 wt %. In a further aspect, the natural sugar is present in the particulate composition in an amount of from about 94 wt % to about 96 wt %. In a still further aspect, the natural sugar is present in the particulate composition in an amount of about 92 wt %, about 93 wt %, about 94 wt %, about 95 wt %, about 96 wt %, or about 97 wt %. In yet a further aspect, the natural sugar is present in the particulate composition in an amount of about 95 wt %.

In various aspects, the salt is a powdered salt, a flour salt, a table salt, or a mixture thereof. In a further aspect, the salt is a flour salt.

In various aspects, the salt is a natural salt or a synthetic (artificial) salt. In a further aspect, the salt is a synthetic or artificial salt. In a still further aspect, the salt is a natural salt. As used herein, the term “natural salt” means an edible salt or salt substitute that is comes from a natural salt. Examples of natural salts include, but are not limited to, sodium chloride (table salt), potassium chloride, potassium lactate, sodium malate, monosodium glutamate, carnallite, kainite, langbeinite, sylvite, polyhalite, epsomite, kieserite, and glasswort. In a further aspect, the natural salt is sodium chloride or potassium chloride.

In various aspects, the salt is a particulate.

In various aspects, the salt is present in the particulate composition in an amount of from about 1.5 wt % to about 2.5 wt %. Thus, in various aspects, the salt is present in the particulate composition in an amount of from about 1.5 wt % to about 2.3 wt %, from about 1.5 wt % to about 2.1 wt %, from about 1.5 wt % to about 1.9 wt %, from about 1.5 wt % to about 1.7 wt %, from about 1.7 wt % to about 2.5 wt %, from about 1.9 wt % to about 2.5 wt %, from about 2.1 wt % to about 2.5 wt %, from about 2.3 wt % to about 2.5 wt %, from about 1.7 wt % to about 2.3 wt %, or from about 1.9 wt % to about 2.1 wt %. In a further aspect, the salt is present in the particulate composition in an amount of from about 1.9 wt % to about 2.1 wt %. In a still further aspect, the salt is present in the particulate composition in an amount of about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, or about 2.5 wt %. In yet a further aspect, the salt is present in the particulate composition in an amount of about 2.0 wt %.

As detailed herein, the term “floral flavorant” means a flavorant that can be added to a food or beverage product to enhance or modify the taste, aroma, and/or color of the product to resemble that of a flower. Thus, in various aspects, the floral flavorant is selected from a lavender flavorant, a rose flavorant, a jasmine flavorant, a hibiscus flavorant, a cherry blossom flavorant, an orange blossom flavorant, an osmanthus flavorant, an orchid flavorant, a Gardenia flavorant, a chamomile flavorant, a Chrysanthemum flavorant, a elderflower flavorant, a geranium flavorant, a violet flavorant, and a poppy flavorant, or a mixture thereof. In a further aspect, the floral flavorant is selected from a lavender flavoring agent and a rose flavoring agent, or a mixture thereof. In a still further aspect, the floral flavorant is a rose flavoring agent. In yet a further aspect, the floral flavorant is a lavender flavoring agent.

In various aspects, the floral flavorant is a natural floral flavorant or a synthetic (artificial) floral flavorant. In a further aspect, the floral flavorant is a synthetic floral flavorant. As used herein, the term “synthetic floral flavorant” or “artificial floral flavorant” means a flavorant that mimics the aroma and/or flavor profiles of natural florals, but that is manufactured. In a still further aspect, the floral flavorant is a natural floral flavorant. As used herein, the term “natural floral flavorant” means a botanical ingredient (e.g., flowers, fruit peels) that has been extracted (e.g., via distillation) to afford a floral flavor.

In various aspects, the floral flavorant is a particulate.

In various aspects, the floral flavorant is present in the composition in an amount of from about 1.0 wt % to about 2.0 wt %. Thus, in various aspects, the floral flavorant is present in the composition in an amount of from about 1.0 wt % to about 1.8 wt %, from about 1.0 wt % to about 1.6 wt %, from about 1.0 wt % to about 1.4 wt %, from about 1.0 wt % to about 1.2 wt %, from about 1.2 wt % to about 2.0 wt %, from about 1.4 wt % to about 2.0 wt %, from about 1.6 wt % to about 2.0 wt %, from about 1.8 wt % to about 2.0 wt %, from about 1.2 wt % to about 1.8 wt %, or from about 1.4 wt % to about 1.6 wt %. In a further aspect, the floral flavorant is present in the composition in an amount of about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, or about 2.0 wt %. In a still further aspect, the floral flavorant is present in the composition in an amount of about 1.4 wt %.

As detailed herein, the term “natural colorant” means an edible dye, pigment, or other substances that can be used to modify the color of a food or beverage product, and that is derived from a naturally occurring substance such as pure vegetable juice or spice. Thus, in various aspects, the natural colorant comprises one or more selected from annatto extract, beet juice, beet juice concentrate, beta carotene, carrot juice, carrot concentrate, black currant juice, black currant concentrate, blue spirulina extract, butterfly pea powder, elderberry juice, elderberry concentrate, grape juice, grape juice concentrate, hibiscus fruit juice, hibiscus fruit concentrate, paprika, carmine, sweet potato extract, red cabbage extract, red radish extract, riboflavin, and turmeric (curcumin). In a further aspect, the natural colorant comprises one or more selected from carrot concentrate and black currant concentrate.

In various aspects, the natural colorant is a particulate.

In various aspects, the natural colorant is present in the composition in an amount of from about 0.9 wt % to about 1.3 wt % of a natural colorant. Thus, in various aspects, the natural colorant is present in the composition in an amount of from about 0.9 wt % to about 1.3 wt % of a natural colorant, from about 0.9 wt % to about 1.2 wt % of a natural colorant, from about 0.9 wt % to about 1.1 wt % of a natural colorant, from about 0.9 wt % to about 1.0 wt % of a natural colorant, from about 1.0 wt % to about 1.3 wt % of a natural colorant, from about 1.1 wt % to about 1.3 wt % of a natural colorant, from about 1.2 wt % to about 1.3 wt % of a natural colorant, or from about 1.0 wt % to about 1.2 wt % of a natural colorant. In a further aspect, the natural colorant is present in the composition in an amount of about 0.9 wt %, about 1.0 wt %, about 1.1 wt %, about 1.2 wt %, or about 1.3 wt %. In a still further aspect, the natural colorant is present in the composition in an amount of about 1.1 wt %.

In various aspects, the oil is selected from almond oil, avocado oil, coconut oil, corn oil, olive oil, palm oil, sesame oil, soybean oil, canola oil, apricot kernel oil, and grapeseed oil, or a mixture thereof. In a further aspect, the oil is soybean oil.

In various aspects, the oil is a natural oil or a synthetic (artificial) oil. In a further aspect, the oil is a synthetic or artificial oil. As used herein, the term “synthetic oil” means an edible oil (liquid) that is manufactured and that can be used for frying, baking, and other types of cooking, as well as to flavor food and beverage products. In a still further aspect, the oil is a natural oil. As used herein, the term “natural oil” means an edible oil (liquid) that is derived from a plant or an animal via, for example, extraction.

In various aspects, the oil is a particulate.

In various aspects, the oil is present in the composition in an amount of from about 0.08 wt % to about 0.12 wt %. Thus, in various aspects, the oil is present in the composition in an amount of from about 0.08 wt % to about 0.11 wt %, from about 0.08 wt % to about 0.10 wt %, from about 0.08 wt % to about 0.09 wt %, from about 0.09 wt % to about 0.12 wt %, from about 0.10 wt % to about 0.12 wt %, from about 0.11 wt % to about 0.12 wt %, or from about 0.09 wt % to about 0.11 wt %. In a further aspect, the oil is present in the composition in an amount of about 0.08 wt %, about 0.09 wt %, about 0.10 wt %, about 0.11 wt %, or about 0.12 wt %. In a still further aspect, the oil is present in the composition in an amount of about 0.10 wt %.

In various aspects, the oil is present in the composition in an amount of from about 0.08 wt % to about 0.12 wt %. Thus, in various aspects, the oil is present in the composition in an amount of from about 0.08 wt % to about 0.11 wt %, from about 0.08 wt % to about 0.10 wt %, from about 0.08 wt % to about 0.09 wt %, from about 0.09 wt % to about 0.12 wt %, from about 0.10 wt % to about 0.12 wt %, from about 0.11 wt % to about 0.12 wt %, or from about 0.09 wt % to about 0.11 wt %. In a further aspect, the oil is present in the composition in an amount of about 0.10 wt %.

As detailed herein, the amount of the floral flavorant relative to the other components in the particulate composition (e.g., the natural sugar, the salt, the natural colorant, the oil) can be selected to minimize the herbaceous undertones that are imparted by the particulate composition. Thus, in various aspects, the ratio of the natural sugar, the salt, the natural colorant, and/or the oil to the floral flavorant is selected. In a further aspect, the ratio of one of the natural sugar, the salt, the natural colorant, and the oil to the floral flavorant is selected. In a still further aspect, the ratio of at least two of the natural sugar, the salt, the natural colorant, and the oil to the floral flavorant is selected. In yet a further aspect, the ratio of at least three of the natural sugar, the salt, the natural colorant, and the oil to the floral flavorant is selected. In an even further aspect, the ratio of each of the natural sugar, the salt, the natural colorant, and the oil to the floral flavorant is selected.

In various aspects, the ratio of the natural sugar to the floral flavorant is selected. Thus, in various aspects, the natural sugar and the floral flavorant are present in the particulate composition in a ratio of from about 46 to about 97. In a further aspect, the natural sugar and the floral flavorant are present in the particulate composition in a ratio of from about 46 to about 95, from about 46 to about 90, from about 46 to about 85, from about 46 to about 80, from about 46 to about 75, from about 46 to about 70, from about 46 to about 65, from about 46 to about 60, from about 46 to about 55, from about 46 to about 50, from about 50 to about 97, from about 55 to about 97, from about 60 to about 97, from about 65 to about 97, from about 70 to about 97, from about 75 to about 97, from about 80 to about 97, from about 85 to about 97, from about 90 to about 97, from about 50 to about 95, from about 55 to about 90, from about 60 to about 85, from about 65 to about 80, or from about 70 to about 75. In a still further aspect, the natural sugar and the floral flavorant are present in the particulate composition in a ratio of from about 60 to about 75. In yet a further aspect, the natural sugar and the floral flavorant are present in the particulate composition in a ratio of about 68.

In various aspects, the ratio of the salt to the floral flavorant is selected. Thus, in various aspects, the salt and the floral flavorant are present in the particulate composition in a ratio of from about 0.75 to about 2.5. In a further aspect, the salt and the floral flavorant are present in the particulate composition in a ratio of from about 0.75 to about 2.3, from about 0.75 to about 2.0, from about 0.75 to about 1.8, from about 0.75 to about 1.5, from about 0.75 to about 1.3, from about 0.75 to about 1.0, from about 1.0 to about 2.5, from about 1.3 to about 2.5, from about 1.5 to about 2.5, from about 1.8 to about 2.5, from about 2.0 to about 2.5, from about 2.3 to about 2.5, from about 1.0 to about 2.3, from about 1.3 to about 2.0, or from about 1.5 to about 1.8. In a still further aspect, the salt and the floral flavorant are present in the particulate composition in a ratio of from about 1.2 to about 1.6. In yet a further aspect, the salt and the floral flavorant are present in the particulate composition in a ratio of about 1.4.

In various aspects, the ratio of the natural colorant to the floral flavorant is selected. Thus, in various aspects, the natural colorant and the floral flavorant are present in the particulate composition in a ratio of from about 0.45 to about 1.3. In a further aspect, the natural colorant and the floral flavorant are present in the particulate composition in a ratio of from about 0.45 to about 1.1, from about 0.45 to about 0.9, from about 0.45 to about 0.7, from about 0.5 to about 1.3, from about 0.7 to about 1.3, from about 0.9 to about 1.3, from about 1.1 to about 1.3, from about 0.5 to about 1.1, or from about 0.7 to about 0.9. In a still further aspect, the natural colorant and the floral flavorant are present in the particulate composition in a ratio of from about 0.75 to about 0.85. In yet a further aspect, the natural colorant and the floral flavorant are present in the particulate composition in a ratio of about 0.79.

In various aspects, the ratio of the oil to the floral flavorant is selected. Thus, in various aspects, the oil and the floral flavorant are present in the particulate composition in a ratio of from about 0.04 to about 0.12. In a further aspect, the oil and the floral flavorant are present in the particulate composition in a ratio of from about 0.04 to about 0.10, from about 0.04 to about 0.08, from about 0.04 to about 0.06, from about 0.06 to about 0.12, from about 0.08 to about 0.12, from about 0.10 to about 0.12, or from about 0.06 to about 0.10. In a still further aspect, the oil and the floral flavorant are present in the particulate composition in a ratio of from about 0.06 to about 0.08. In yet a further aspect, the oil and the floral flavorant are present in the particulate composition in a ratio of about 0.071.

In various aspects, the natural sugar and the floral flavorant are present in the composition in a ratio of from about 46 to about 97, wherein the salt and the floral flavorant are present in the composition in a ratio of from about 0.75 to about 2.5, and wherein the natural colorant and the floral flavorant are present in the composition in a ratio of from about 0.45 to about 1.3.

In various aspects, the particulate composition comprises the natural sugar, a natural salt, a natural floral flavorant, a natural colorant, and a natural oil.

In various aspects, the particulate composition comprises: (a) from about 92 wt % to about 97 wt % of the natural sugar; (b) from about 1.5 wt % to about 2.5 wt % of the salt; (c) from about 1.0 wt % to about 2.0 wt % of the floral flavorant; (d) from about 0.9 wt % to about 1.3 wt % of the natural colorant; and (c) from about 0.08 wt % to about 0.12 wt % of the oil. In a further aspect, the natural sugar is a cane sugar, the natural salt is a flour salt, and the oil is soybean oil. In a still further aspect, the floral flavorant is selected from a natural lavender flavoring agent and a natural rose flavoring agent, or a mixture thereof. In yet a further aspect, the floral flavorant is a natural lavender flavoring agent. In a further aspect, the natural colorant comprises one or more selected from carrot concentrate and black currant concentrate. In a still further aspect, the natural colorant comprises one or more selected from carrot concentrate and black currant concentrate.

In various aspects, the particulate composition comprises: (a) from about 92 wt % to about 97 wt % of a cane sugar; (b) from about 1.5 wt % to about 2.5 wt % of a flour salt; (c) from about 1.0 wt % to about 2.0 wt % of a natural lavender flavoring agent; (d) from about 0.9 wt % to about 1.3 wt % of a natural colorant comprising carrot concentrate, black currant concentrate, or a mixture thereof; and (c) from about 0.08 wt % to about 0.12 wt % of soybean oil.

In various aspects, the particulate composition comprises particles having a D90 of from about 74 microns to about 297 microns. Thus, in various aspects, the particulate composition comprises particles having a D90 of from about 74 microns to about 295 microns, from about 74 microns to about 275 microns, from about 74 microns to about 250 microns, from about 74 microns to about 225 microns, from about 74 microns to about 200 microns, from about 74 microns to about 175 microns, from about 74 microns to about 150 microns, from about 74 microns to about 125 microns, from about 74 microns to about 100 microns, from about 100 microns to about 297 microns, from about 125 microns to about 297 microns, from about 150 microns to about 297 microns, from about 175 microns to about 297 microns, from about 200 microns to about 297 microns, from about 225 microns to about 297 microns, from about 250 microns to about 297 microns, from about 100 microns to about 275 microns, from about 125 microns to about 250 microns, from about 150 microns to about 225 microns, or from about 175 microns to about 200 microns.

### 1. Properties

As detailed further herein, the disclosed particulate compositions can have various properties, including small particle size (e.g., a fine or super fine powder), pale color (e.g., a light purple color), a low bulk density, a low water activity, a sweet aroma, and an only slightly herbaceous undertone. It is also understood that the disclosed compositions have other properties.

In various aspects, the particulate composition comprises a fine or super fine powder. In a further aspect, the particulate composition consists essentially of a fine or super fine powder. Thus, in various aspects, the particulate composition comprises particles having a D90 of from about 74 microns to about 297 microns. In various further aspects, the particulate composition comprises particles having a D90 of from about 74 microns to about 295 microns, from about 74 microns to about 275 microns, from about 74 microns to about 250 microns, from about 74 microns to about 225 microns, from about 74 microns to about 200 microns, from about 74 microns to about 175 microns, from about 74 microns to about 150 microns, from about 74 microns to about 125 microns, from about 74 microns to about 100 microns, from about 100 microns to about 297 microns, from about 125 microns to about 297 microns, from about 150 microns to about 297 microns, from about 175 microns to about 297 microns, from about 200 microns to about 297 microns, from about 225 microns to about 297 microns, from about 250 microns to about 297 microns, from about 100 microns to about 275 microns, from about 125 microns to about 250 microns, from about 150 microns to about 225 microns, or from about 175 microns to about 200 microns.

In various aspects, the particulate composition has a pale color such as, for example, a pale red (rose) or pale purple (lavender) color. The pale color beneficially allows for the color to be imparted in, for example, a foam comprising a sweet cream, while minimizing the color imparted to a beverage. Thus, the color of the beverage is only minimally impacted, or is not impacted at all, by the addition of the particulate composition.

In various aspects, the particulate composition has a low bulk density. As used herein, the term “bulk density” means the weight of a volume unit of powder and is usually expressed in g/cm³, kg/m³, g/100 mL, or lb/ft³. As would be appreciated by one of ordinary skill, the bulk density of a substance can be determined by, for example, measuring the volume of 100 g of a powder in a 250 mL graduated cylinder after exposure to compaction by standard tapping. Alternative techniques for measuring bulk density are well-known in the art. The bulk density of a powder can include additional properties of a powder, including flowability and instant characteristics. Thus, in various aspects, the particulate composition has a bulk density of from about 40 lb/ft³ to about 60 lb/ft³. In a further aspect, the particulate composition has a bulk density of from about 40 lb/ft³ to about 55 lb/ft³, from about 40 lb/ft³ to about 50 lb/ft³, from about 40 lb/ft³ to about 45 lb/ft³, from about 45 lb/ft³ to about 60 lb/ft³, from about 50 lb/ft³ to about 60 lb/ft³, from about 55 lb/ft³ to about 60 lb/ft³, or from about 45 lb/ft³ to about 55 lb/ft³. In a still further aspect, the particulate composition has a bulk density of from about 45 lb/ft³ to about 55 lb/ft³.

In various aspects, the particulate composition has a low water activity. As used herein, the term “water activity” means the ratio between the vapor pressure of the product (e.g., the particulate composition), when in a completely undisturbed balance with the surrounding air media, and the vapor pressure of distilled water under identical conditions. A vapor activity of 0.80, for example, means that the vapor pressure is 80% that of pure water. Water activity can, therefore, be used as a measure of the moisture condition of a product. Thus, in various aspects, the particulate composition has a water activity of less than about 0.8. In a further aspect, the particulate composition has a water activity of less than about 0.75, less than about 0.7, less than about 0.65, less than about 0.6, less than about 0.55, or less than about 0.5. In a still further aspect, the particulate composition has a water activity of less than about 0.6.

In various aspects, the particulate composition comprises particles having a D90 of from about 74 microns to about 297 microns, wherein the particulate composition has a bulk density of from about 40 lb/ft³ to about 60 lb/ft³, and wherein the particulate composition has a water activity of less than about 0.8.

In various aspects, the particulate composition consists essentially of particles having a D90 of from about 74 microns to about 297 microns, wherein the particulate composition has a bulk density of from about 45 lb/ft³ to about 55 lb/ft³, and wherein the particulate composition has a water activity of less than about 0.6.

In various aspects, the particulate composition has a sweet aroma (e.g., a sweet floral aroma). In this way, the particulate composition can endow a similar aroma to the foam and/or to the beverage. Thus, in various aspects, the particulate composition has a lavender aroma, a rose aroma, a jasmine aroma, a hibiscus aroma, a cherry blossom aroma, an orange blossom aroma, an osmanthus aroma, an orchid aroma, a Gardenia aroma, a chamomile aroma, a Chrysanthemum aroma, a elderflower aroma, a geranium aroma, a violet aroma, and a poppy aroma, or a mixture thereof.

In various aspects, the particulate composition has minimal herbaceous undertones. Thus, as detailed herein, the disclosed particulate compositions beneficially have a sweet flavor with floral undertones that minimizes the accompanying herbaceous undertones.

### C. FOAMS

In one aspect, disclosed are foams comprising a sweet cream and a disclosed particulate composition. In a further aspect, the particulate composition comprises: (a) a natural sugar; (b) a salt; (c) a floral flavorant; (d) a natural colorant; and (e) an oil, wherein the oil and the floral flavorant are present in the particulate composition in a ratio of from about 0.04 to about 0.12.

Without wishing to be bound by theory, a disclosed particulate composition can be used to add flavor to a foam, to change the aroma of a foam, and/or to change the visual appearance of a foam. For example, a disclosed particulate composition can be used to add a sweet flavor to a foam. As detailed herein, the sweet flavor can impart floral (e.g., lavender, rose) tones with only minimal herbaceous undertones. Alternatively, a disclosed particulate composition can be used to change the aroma of a foam such as, for example, to add a sweet, floral aroma. Again, herbaceous undertones in the aroma are minimized. A disclosed particulate composition can also be used to change the visual appearance of the foam. For example, when incorporated into a foam, the resultant foam can turn a light color (e.g., a light purple color, a light rose color) based on the color of the particulate composition.

In various aspects, the flavor and the aroma can be matched such that the floral flavor (e.g., lavender flavor, rose flavor) added to the beverage complements the floral aroma (e.g., lavender aroma, rose aroma). Similarly, the color (e.g., light purple, light red) can also be matched with the floral flavor (e.g., lavender flavor, rose flavor) and/or the floral aroma (e.g., lavender aroma, rose aroma). In this way, the foam conveys a united sensory experience (e.g., of lavender, of rose, etc.).

Exemplary sweet creams are known in the art and include, but are not limited to, a vanilla sweet cream, a hazelnut sweet cream, a caramel sweet cream, a chocolate sweet cream, a honey sweet cream, a chestnut praline sweet cream, a sugar cookie sweet cream, a peppermint sweet cream, a cinnamon sweet cream, a raspberry sweet cream, a toffeenut sweet cream, an Irish cream sweet cream, a macadamia sweet cream, or a mixture thereof. In a further aspect, the sweet cream is a vanilla sweet cream.

In various aspects, the sweet cream is present in the foam in an amount of from about 85 wt % to about 95 wt %. Thus, in various aspects, the sweet cream is present in the foam in an amount of from about 85 wt % to about 93 wt %, from about 85 wt % to about 91 wt %, from about 85 wt % to about 89 wt %, from about 85 wt % to about 87 wt %, from about 87 wt % to about 95 wt %, from about 89 wt % to about 95 wt %, from about 91 wt % to about 95 wt %, from about 93 wt % to about 95 wt %, from about 87 wt % to about 93 wt %, or from about 89 wt % to about 91 wt %. In a further aspect, the sweet cream is present in the foam in an amount of from about 90 wt % to about 92 wt %. In a still further aspect, the sweet cream is present in the foam in an amount of about 85 wt %, about 86 wt %, about 87 wt %, about 88 wt %, about 89 wt %, about 90 wt %, about 91 wt %, about 92 wt %, or about 93 wt %. In yet a further aspect, the sweet cream is present in the foam in an amount of about 91 wt %.

In various aspects, the particulate composition is present in the foam in an amount of from about 5 wt % to about 15 wt %. Thus, in various aspects, the particulate composition is present in the foam in an amount of from about 5 wt % to about 13 wt %, from about 5 wt % to about 11 wt %, from about 5 wt % to about 9 wt %, from about 5 wt % to about 7 wt %, from about 7 wt % to about 15 wt %, from about 9 wt % to about 11 wt %, from about 13 wt % to about 15 wt %, from about 7 wt % to about 13 wt %, or from about 9 wt % to about 11 wt %. In a further aspect, the particulate composition is present in the foam in an amount of from about 8 wt % to about 10 wt %. In a still further aspect, the particulate composition is present in the foam in an amount of about 5 wt %, about 6 wt %, about 7 wt %, about 8 wt %, about 9 wt %, about 10 wt %, about 11 wt %, about 12 wt %, about 13 wt %, about 14 wt %, or about 15 wt %. In yet a further aspect, the particulate composition is present in the foam in an amount of about 9 wt %.

In various aspects, the floral flavorant is present in the foam in an amount of from about 0.050 wt % to about 0.15 wt %. Thus, in various aspects, the floral flavorant is present in the foam in an amount of from about 0.050 wt % to about 0.13 wt %, from about 0.050 wt % to about 0.11 wt %, from about 0.050 wt % to about 0.090 wt %, from about 0.050 wt % to about 0.070 wt %, from about 0.070 wt % to about 0.15 wt %, from about 0.090 wt % to about 0.15 wt %, from about 0.11 wt % to about 0.15 wt %, from about 0.13 wt % to about 0.15 wt %, from about 0.070 wt % to about 0.13 wt %, or from about 0.090 wt % to about 0.11 wt %. In a further aspect, the floral flavorant is present in the foam in an amount of from about 0.12 wt % to about 0.14 wt %. In a still further aspect, the floral flavorant is present in the foam in an amount of about 0.050 wt %, about 0.060 wt %, about 0.070 wt %, about 0.080 wt %, about 0.090 wt %, about 0.10 wt %, about 0.11 wt %, about 0.12 wt %, about 0.13 wt %, about 0.14 wt %, or about 0.15 wt %. In yet a further aspect, the floral flavorant is present in the foam in an amount of about 0.13 wt %.

As detailed herein, the amount of the floral flavorant relative to the other components in the foam (e.g., the natural sugar, the salt, the natural colorant, the oil) can be selected to minimize the herbaceous undertones that are imparted by the foam. Thus, in various aspects, the ratio of the natural sugar, the salt, the natural colorant, and/or the oil to the floral flavorant is selected. In a further aspect, the ratio of one of the natural sugar, the salt, the natural colorant, and the oil to the floral flavorant is selected. In a still further aspect, the ratio of at least two of the natural sugar, the salt, the natural colorant, and the oil to the floral flavorant is selected. In yet a further aspect, the ratio of at least three of the natural sugar, the salt, the natural colorant, and the oil to the floral flavorant is selected. In an even further aspect, the ratio of each of the natural sugar, the salt, the natural colorant, and the oil to the floral flavorant is selected.

In various aspects, the ratio of the natural sugar to the floral flavorant is selected. Thus, in various aspects, the natural sugar and the floral flavorant are present in the foam in a ratio of from about 46 to about 97. In a further aspect, the natural sugar and the floral flavorant are present in the foam in a ratio of from about 46 to about 95, from about 46 to about 90, from about 46 to about 85, from about 46 to about 80, from about 46 to about 75, from about 46 to about 70, from about 46 to about 65, from about 46 to about 60, from about 46 to about 55, from about 46 to about 50, from about 50 to about 97, from about 55 to about 97, from about 60 to about 97, from about 65 to about 97, from about 70 to about 97, from about 75 to about 97, from about 80 to about 97, from about 85 to about 97, from about 90 to about 97, from about 50 to about 95, from about 55 to about 90, from about 60 to about 85, from about 65 to about 80, or from about 70 to about 75. In a still further aspect, the natural sugar and the floral flavorant are present in the foam in a ratio of from about 60 to about 75. In yet a further aspect, the natural sugar and the floral flavorant are present in the foam in a ratio of about 68.

In various aspects, the ratio of the salt to the floral flavorant is selected. Thus, in various aspects, the salt and the floral flavorant are present in the foam in a ratio of from about 0.75 to about 2.5. In a further aspect, the salt and the floral flavorant are present in the foam in a ratio of from about 0.75 to about 2.3, from about 0.75 to about 2.0, from about 0.75 to about 1.8, from about 0.75 to about 1.5, from about 0.75 to about 1.3, from about 0.75 to about 1.0, from about 1.0 to about 2.5, from about 1.3 to about 2.5, from about 1.5 to about 2.5, from about 1.8 to about 2.5, from about 2.0 to about 2.5, from about 2.3 to about 2.5, from about 1.0 to about 2.3, from about 1.3 to about 2.0, or from about 1.5 to about 1.8. In a still further aspect, the salt and the floral flavorant are present in the foam in a ratio of from about 1.2 to about 1.6. In yet a further aspect, the salt and the floral flavorant are present in the foam in a ratio of about 1.4.

In various aspects, the ratio of the natural colorant to the floral flavorant is selected. Thus, in various aspects, the natural colorant and the floral flavorant are present in the foam in a ratio of from about 0.45 to about 1.3. In a further aspect, the natural colorant and the floral flavorant are present in the foam in a ratio of from about 0.45 to about 1.1, from about 0.45 to about 0.9, from about 0.45 to about 0.7, from about 0.5 to about 1.3, from about 0.7 to about 1.3, from about 0.9 to about 1.3, from about 1.1 to about 1.3, from about 0.5 to about 1.1, or from about 0.7 to about 0.9. In a still further aspect, the natural colorant and the floral flavorant are present in the foam in a ratio of from about 0.75 to about 0.85. In yet a further aspect, the natural colorant and the floral flavorant are present in the foam in a ratio of about 0.79.

In various aspects, the ratio of the oil to the floral flavorant is selected. Thus, in various aspects, the oil and the floral flavorant are present in the foam in a ratio of from about 0.04 to about 0.12. In a further aspect, the oil and the floral flavorant are present in the foam in a ratio of from about 0.04 to about 0.10, from about 0.04 to about 0.08, from about 0.04 to about 0.06, from about 0.06 to about 0.12, from about 0.08 to about 0.12, from about 0.10 to about 0.12, or from about 0.06 to about 0.10. In a still further aspect, the oil and the floral flavorant are present in the foam in a ratio of from about 0.06 to about 0.08. In yet a further aspect, the oil and the floral flavorant are present in the foam in a ratio of about 0.071.

### D. BEVERAGES

In one aspect, disclosed are beverages comprising a disclosed particulate composition. In a further aspect, the particulate composition comprises: (a) a natural sugar; (b) a salt; (c) a floral flavorant; (d) a natural colorant; and (e) an oil, wherein the oil and the floral flavorant are present in the particulate composition in a ratio of from about 0.04 to about 0.12.

In one aspect, disclosed are beverages comprising a disclosed foam. In a further aspect, the foam comprises a sweet cream and a disclosed particulate composition. In a still further aspect, the particulate composition comprises: (a) a natural sugar; (b) a salt; (c) a floral flavorant; (d) a natural colorant; and (e) an oil, wherein the oil and the floral flavorant are present in the particulate composition in a ratio of from about 0.04 to about 0.12. In yet a further aspect, the foam is added on top of the beverage. In an even further aspect, the foam is mixed into the beverage.

Exemplary beverages are known in the art and include, but are not limited to, coffees such as instant coffees, cold brews, hot brews, traditional brews, and blended coffees, teas, fruit juices, smoothies, waters such as still waters and sparkling waters, liquors, liqueurs, and mixtures thereof. In a further aspect, the beverage is a coffee (e.g., instant coffee, cold brew, hot brew, traditional brew, blended coffee), a tea, a fruit juice, a smoothie, or a water (e.g., still, sparkling). In a still further aspect, the beverage is a coffee. In yet a further aspect, the coffee is instant coffee, cold brew, hot brew, traditional brew, or blended coffee. In a still further aspect, the coffee is a blended coffee beverage.

Without wishing to be bound by theory, a disclosed particulate composition can be used to add flavor to a beverage, to change the aroma of a beverage, and/or to change the visual appearance of a beverage. For example, a disclosed particulate composition can be used to add a sweet flavor to a beverage. As detailed herein, the sweet flavor can impart floral (e.g., lavender, rose) tones with only minimal herbaceous undertones. Alternatively, a disclosed particulate composition can be used to change the aroma of a beverage such as, for example, to add a sweet, floral aroma. Again, herbaceous undertones in the aroma are minimized. A disclosed particulate composition can also be used to change the visual appearance of the beverage. For example, as detailed herein, when incorporated into a foam, the resultant foam can turn a light color (e.g., a light purple color, a light rose color) based on the color of the particulate composition. The foam can then be added on top of a beverage such that the color of the beverage remains unchanged (or is changed only minimally), while the foam adds color to the resultant beverage product (the beverage+the foam).

In various aspects, the flavor and the aroma can be matched such that the floral flavor (e.g., lavender flavor, rose flavor) added to the beverage complements the floral aroma (e.g., lavender aroma, rose aroma). Similarly, the color (e.g., light purple, light red) can also be matched with the floral flavor (e.g., lavender flavor, rose flavor) and/or the floral aroma (e.g., lavender aroma, rose aroma). In this way, the beverage conveys a united sensory experience (e.g., of lavender, of rose, etc.).

In various aspects, the beverage is a coffee. In various further aspects, the coffee can be made from one or more of Arabica, Robusta, Liberica beans, and Excelsa beans. In various further aspects, the coffee can be roasted (e.g., a light roast, a medium roast, a dark roast, an extra dark roast). Examples of coffees include, but are not limited to, expressos, instant coffees, cold brews, hot brews, pour overs, drips, iced coffees, and blended coffees (e.g., cappuccinos, lattes, Americanos, cortados, red eyes, mochas, macchiatos, flat whites, café au laits, irish coffees, Frappuccinos®).

In various aspects, the beverage is a tea. Examples of teas include, but are not limited to, black teas, green teas, passion teas, white teas, Earl Grey teas, matcha teas, oolong teas, pu-erh teas, purple teas, and Chai teas.

In various aspects, the beverage is a fruit juice. Examples of fruit juices include, but are not limited to, apple juice, cranberry juice, grape juice, orange juice, grapefruit juice, blueberry juice, kiwi juice, starfruit juice, dragon fruit juice, mango juice, açaí juice, lemonade, and combinations thereof. In various aspects, the fruit juice further comprises additional components such as, for example, an alternative dairy product (e.g., coconut milk), coffee extract, ice, fresh fruit, and/or fruit puree. In various further aspects, the fruit juice is a Refresher™.

In various aspects, the beverage is a smoothie. Examples of smoothies include, but are not limited to, orange smoothies, blueberry smoothies, kiwi smoothies, starfruit smoothies, dragon fruit smoothies, mango smoothies, açaí smoothies, lemonade, banana smoothies, and combinations thereof.

In various aspects, the beverage is a water such as, for example, still water or sparkling water.

### E. KITS

In one aspect, disclosed are kits comprising a disclosed particulate composition and one or more selected from: (a) a sweet cream; (b) a beverage; (c) instructions for making a foam; and (d) instructions for making a beverage. In a further aspect, the particulate composition comprises: (a) a natural sugar; (b) a salt; (c) a floral flavorant; (d) a natural colorant; and (e) an oil, wherein the oil and the floral flavorant are present in the particulate composition in a ratio of from about 0.04 to about 0.12.

Exemplary sweet creams are known in the art and include, but are not limited to, a vanilla sweet cream, a hazelnut sweet cream, a caramel sweet cream, a chocolate sweet cream, a honey sweet cream, a chestnut praline sweet cream, a sugar cookie sweet cream, a peppermint sweet cream, a cinnamon sweet cream, a raspberry sweet cream, a toffeenut sweet cream, an Irish cream sweet cream, a macadamia sweet cream, or a mixture thereof. In a further aspect, the sweet cream is a vanilla sweet cream.

Exemplary beverages are known in the art and include, but are not limited to, coffees such as instant coffees, cold brews, hot brews, traditional brews, and blended coffees, teas, fruit juices, smoothies, waters such as still waters and sparkling waters, liquors, liqueurs, and mixtures thereof. In a further aspect, the beverage is a coffee (e.g., instant coffee, cold brew, hot brew, traditional brew, blended coffee), a tea, a fruit juice, a smoothie, or a water (e.g., still, sparkling). In a still further aspect, the beverage is a coffee. In yet a further aspect, the coffee is instant coffee, cold brew, hot brew, traditional brew, or blended coffee. In a still further aspect, the coffee is a blended coffee beverage.

It is understood that the disclosed kits can be prepared from the disclosed particulate compositions, foams, and beverages. It is also understood that the disclosed kits can be employed in connection with the disclosed methods of using.

The foregoing description illustrates and describes the disclosure. Additionally, the disclosure shows and describes only the preferred embodiments but, as mentioned above, it is to be understood that it is capable to use in various other combinations, modifications, and environments and is capable of changes or modifications within the scope of the invention concepts as expressed herein, commensurate with the above teachings and/or the skill or knowledge of the relevant art. The embodiments described herein above are further intended to explain best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended to the appended claims be construed to include alternative embodiments.

All publications and patent applications cited in this specification are herein incorporated by reference, and for any and all purposes, as if each individual publication or patent application were specifically and individually indicated to be incorporated by reference. In the event of an inconsistency between the present disclosure and any publications or patent application incorporated herein by reference, the present disclosure controls.

### F. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Examples are provided herein to illustrate the invention, and should not be construed as limiting the invention in any way. Examples are provided herein to illustrate the invention and should not be construed as limiting the invention in any way.

### 1. Preparation of Lavender Bakers Sugar

A lavender sugar was prepared using the formula shown in Table 1 below. Briefly, the sugar and salt were pre-weighed and sifted using mesh screen No. 10. The coloring agent and flavors were then pre-weighed and sifted in separate containers, and the sunflower oil was pre-weighed in a separate container. Next, 50% of the sugar was added to a blender, followed by addition of the pre-weighed sugar and salt mixture. 37.5% of sugar was added on top of that, and the mixture was blended at 60 hz. After 2 minutes, the soybean oil was drizzled into the blender. The blender was then restarted and the mixture was blended until well dispersed. After 3 minutes, the blender was stopped and the blades and sides were scraped to ensure that the product was mixed. Then, the pre-weighed coloring agent was added before restarting the blender. After 5 minutes, the blender was stopped and the blades and sides were once again scraped. The pre-weighed flavoring was added and the blender was started on reverse setting. After 5 minutes, the blender was stopped and the blades and sides were scraped. The blender was then reverse engineered and restarted. During the last 5 minutes, 2-3 lbs were pulled from the discharge valve and were added back thru the top of the ribbon. When the ribbon stops, the sample was pulled for IN-PROCESS CHECK. About 1 lb of material was pulled and submitted to quality assurance for analysis. Once released, the product was sifted into a stainless steel tote using mesh screen No. 10 and the batch was recorded. Summary of the processing parameters: double ribbon blender, 30 min. blend time, 60 Hz.

TABLE 1

| Component | Ingredient Name | Percent |
|---|---|---|
| Cane sugar | Sugar, Bakers Special Extra Fine (Domino) | 95.37 |
| Salt | Salt, Flour (Cargill) | 2 |
| Natural Lavender Flavor | Nat Lavender Flavor 050024 | 1.42 |
| | 1828TPK2054 (Firmenich) | |
| Fruit & vegetable juice for | Color, Vivid Red Powder (GNT, Exberry) | 1.11 |
| color | | |
| Soybean oil | Organic Soybean Oil #200 (Columbus | 0.100 |
| | Vegetable oils) | |
| | | 100.000 |

### 2. Analysis of Physical and Chemical Properties of Lavender Sugar

The physical and chemical properties of the exemplary composition were assessed and are summarized in Table 2 below.

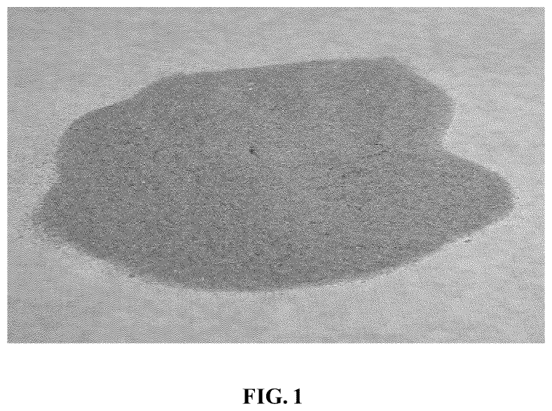

TABLE 2
Physical Properties

| | |
|---|---|
| Color/appearance | Super fine powder with light purple color (see FIG. 1) |
| Color | Pantone 5235 U |
| Viscosity | N/A |
| Texture | Fine, free flowing powder with no lumps |

Chemical Properties

| | |
|---|---|
| Bulk density | 45-55 lb/ft³ (0.72-0.88 g/ml) |
| Water activity | <0.6 |

### 3. Preparation of Lavender Foam

A lavender foam was prepared by combining 10.2 g of the lavender powder with 106 g vanilla sweet cream. The resultant mixture was then blended on 3 in a cold foam blender.

The exemplary foam was evaluated for its sensory properties. See Table 3. It is noted that the product should match the approved Control Gold Standard in all attributes.

TABLE 3
Sensory Properties

| | |
|---|---|
| Aroma | Sweet, lavender floral tones with slight herbaceous undertone |
| Flavor | Sweet, lavender floral tones with slight herbaceous undertone |

### 4. Additional Properties of the Lavender Sugar

Shelf Life. The lavender sugar was found to have a shelf life (unopened) of 180 days at ambient temperature (although this may be extended pending shelf life testing). The shelf life (opened) was 14 days from the date of opening.

Microbiological Properties. The microbiological properties of the lavender sugar were evaluated and are summarized in Table 4 below.

TABLE 4
Microbiological Properties

| | | |
|---|---|---|
| APC | <10,000 | cfu/g |
| Mold | <100 | cfu/g |
| Yeast | <100 | cfu/g |
| Enterobacteriaceae | <10 | cfu/g |

| | |
|---|---|
| Salmonella | Negative/25 g |

### 5. Handling and Storage Requirements

A summary of the handling and storage requirements is shown in Table 5 below.

TABLE 5

| | Supplier to | RDC | RDC to | Store | Store |
|---|---|---|---|---|---|
| | DC | storage | store | (unopened) | (opened) |
| Handling/Storage | Ambient | Ambient | Ambient | Ambient | Ambient |
| Requirements/ | conditions | conditions | conditions | conditions | conditions |
| Recommendation: | (60-90 F.) | (60-90 F.) | (60-90 F.) | (60-90 F.) | (60-90 F.) |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A particulate composition comprising:
(a) a natural sugar;
(b) a salt;
(c) a floral flavorant;
(d) a natural colorant; and
(e) an oil,
wherein the oil and the floral flavorant are present in the composition in a ratio of from about 0.040 to about 0.12.

2. The particulate composition of claim 1, wherein the natural sugar and the floral flavorant are present in the composition in a ratio of from about 46 to about 97.

3. The particulate composition of claim 1, wherein the natural sugar is present in the composition in an amount of from about 92 wt % to about 97 wt %.

4. The particulate composition of claim 1, wherein the natural sugar comprises fructose, glucose, lactose, galactose, maltose, and sucrose, or a mixture thereof.

5. The particulate composition of claim 1, wherein the natural sugar is a cane sugar.

6. The particulate composition of claim 1, wherein the salt and the floral flavorant are present in the composition in a ratio of from about 0.75 to about 2.5.

7. The particulate composition of claim 1, wherein the salt is present in the composition in an amount of from about 1.5 wt % to about 2.5 wt %.

8. The particulate composition of claim 1, wherein the salt is a flour salt.

9. The particulate composition of claim 1, wherein the floral flavorant is present in the composition in an amount of from about 1.0 wt % to about 2.0 wt %.

10. The particulate composition of claim 1, wherein the floral flavorant is a lavender flavorant.

11. The particulate composition of claim 1, wherein the natural colorant and the floral flavorant are present in the composition in a ratio of from about 0.45 to about 1.3.

12. The particulate composition of claim 1, wherein the natural colorant is present in the composition in an amount of from about 0.9 wt % to about 1.3 wt % of a natural colorant.

13. The particulate composition of claim 1, wherein the natural colorant comprises one or more selected from carrot concentrate and black currant concentrate.

14. The particulate composition of claim 1, wherein the oil is present in the composition in an amount of from about 0.08 wt % to about 0.12 wt %.

15. The particulate composition of claim 1, wherein the oil is soybean oil.

16. The particulate composition of claim 1, wherein the particulate composition comprises:
(a) from about 92 wt % to about 97 wt % of the natural sugar;
(b) from about 1.5 wt % to about 2.5 wt % of the salt;
(c) from about 1.0 wt % to about 2.0 wt % of the floral flavorant;
(d) from about 0.9 wt % to about 1.3 wt % of the natural colorant; and
(e) from about 0.08 wt % to about 0.12 wt % of the oil.

17. The particulate composition of claim 1, wherein the particulate composition comprises particles having a D90 of from about 74 microns to about 297 microns.

18. A foam comprising a sweet cream and the particulate composition of claim 1.

19. A beverage comprising the foam of claim 18.

20. A beverage comprising the particulate composition of claim 1.
